(19) United States
(12) Patent Application Publication
(10) Pub. No.: US 2013/0092485 A1
(43) Pub. Date: Apr. 18, 2013

(54) BRAKE DISK ASSEMBLY

(71) Applicant: Wayne-Ian Moore, Changhua City (TW)

(72) Inventor: Wayne-Ian Moore, Changhua City (TW)

(21) Appl. No.: 13/272,239

(22) Filed: Oct. 13, 2011

(51) Int. Cl. F16D 65/12; F16D 65/847

(52) U.S. Cl. 188/218 XL

(57) ABSTRACT

A brake disk assembly includes a main plate clamped between the first and second inner plates. The main plate is movable relative to the first and second inner plates. The contact area between main plate and the first and second inner plates is increased to firmly connect the main plate and the first and second inner plates.

### FIELD OF THE INVENTION

The present invention relates to a brake disk assembly, and more particularly, to a main disk movably clamped between two inner disks.

### BACKGROUND OF THE INVENTION

A conventional brake disk is fixed to the axle of the wheel and the brake unit clamps the brake disk to stop the wheel. High temperature is generated during clamping and the heat is transmitted to the spokes and even soften the brake disk which becomes weak and easily deformed.

An improved conventional brake disk assembly generally includes a fixing plate with a friction plate connected to the outside thereof. The fixing plate has a notch and the friction plate has another notch which is matched with the notch of the fixing plate, a locking member extends through the two aligned notches and connects the fixing plate and the friction plate. The sudden braking force is buffered and absorbed by the gap between the fixing plate and the friction plate.

However, the connection between the fixing plate and the friction plate is composed multiple connection points which are not strong enough for bearing the clamping force when braking.

The present invention intends to provide a brake disk assembly which improves the shortcomings of the conventional connection between the fixing plate and the friction plate.

### SUMMARY OF THE INVENTION

The main objective of the present invention is to provide an improved brake disk assembly.

To achieve the objective, a brake disk assembly comprises a main plate having a connection hole defined therethrough and multiple protrusions extending from an inner periphery of the connection hole, a first inner plate having multiple first slots which are located corresponding to the protrusions, an outer periphery of the first inner plate connected with the connection hole, a second inner plate having multiple second slots which are located corresponding to the protrusions, an outer periphery of the second inner plate connected with the connection hole; wherein the main plate is movably connected between the first and second inner plates; the large contact area between the main plate and the first and second inner plates leads to that the brake disk assembly is more reliable and the wearing of the main plate is reduced.

The first and second inner plates are shaped to be correspondent to the connection hole.

The first and second inner plates respectively protrude from two sides of the main plate.

The first inner plate has first engaging holes and the second inner plate has second engaging holes which are located corresponding to the first engaging holes, bolts or rivets extending through the first and second engaging holes to connect the first and second inner plates.

The main plate has multiple ventilation holes.

Further benefits and advantages of the present invention will become apparent after a careful reading of the detailed description with appropriate reference to the accompanying drawings.

### BRIEF DESCRIPTION OF THE DRAWINGS

FIG. 1 is an exploded view of a brake disk assembly in accordance with the present invention;

FIG. 2 is a partially assembled view of the brake disk assembly in accordance with the present invention;

FIG. 3 is a perspective view of the brake disk assembly in accordance with the present invention; and

FIG. 4 is a cross-sectional view of the brake disk assembly along a line A-A shown in FIG. 3.

### DETAILED DESCRIPTION OF THE PREFERRED EMBODIMENT

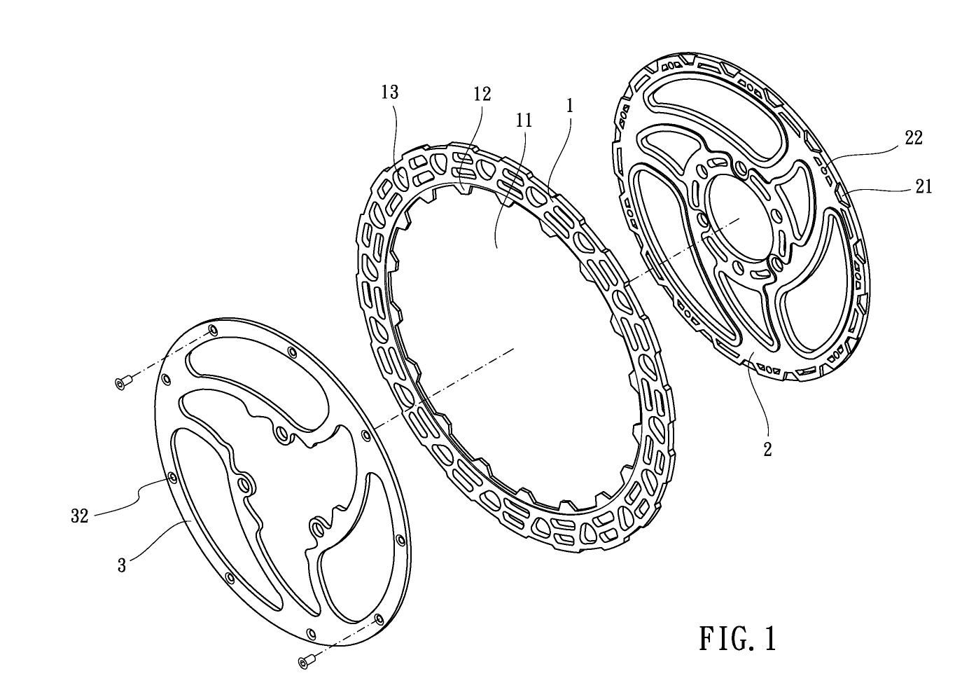

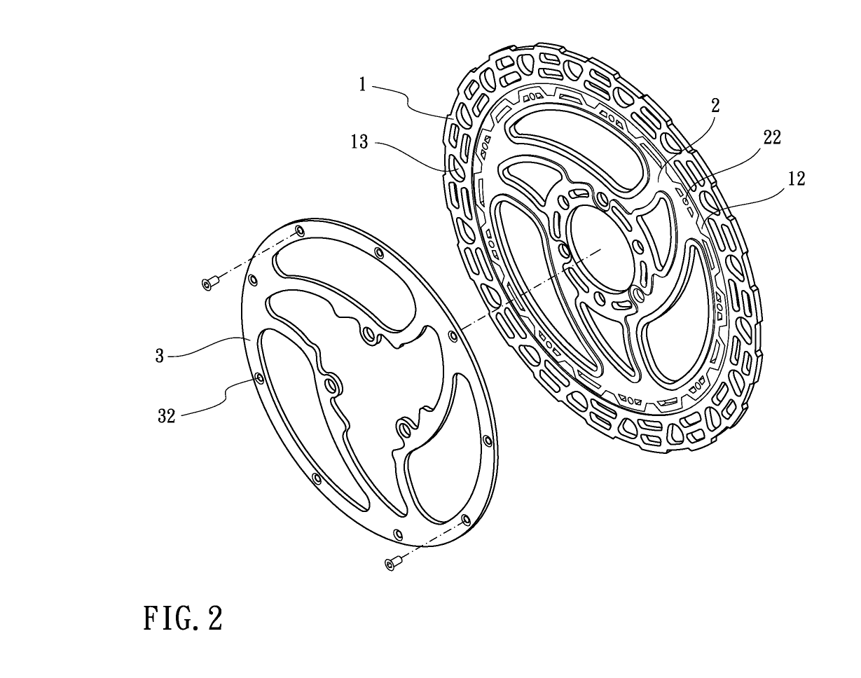

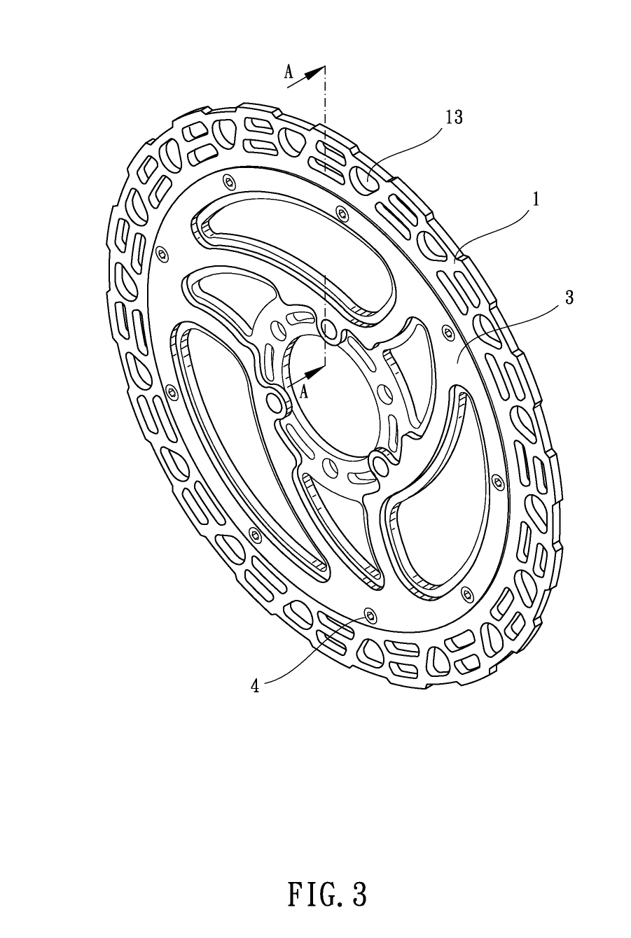

Referring to FIGS. 1 to 3, the brake disk assembly of the present invention comprises a main plate 1, a first inner plate 2 and a second inner plate 3. The main plate 1 is clamped between the first and second inner plates 2, 3.

The main plate 1 has a connection hole 11 defined centrally therethrough and multiple protrusions 12 extend from the inner periphery of the connection hole 10. The protrusions 12 are formed equidistantly. The main plate 1 has multiple ventilation holes 13 which have different sizes. The heat generated during braking escapes from the brake disk assembly via the ventilation holes 13.

The first inner plate 2 is shaped to be correspondent to the connection hole 11 so that the outer periphery of the first inner plate 2 is connected with the connection hole 11 at one side. The first inner plate 2 has multiple first slots 21 which are located corresponding to the protrusions 12. The protrusions 12 are engaged with the first slots 21. In this embodiment, there are eighteen protrusions 12 and eighteen first slots 21.

The second inner plate 3 is shaped to be correspondent to the connection hole 11 so that the outer periphery of the second dinner plate 3 is connected with the connection hole 11 at another side. The main plate 1 is clamped between the first and second inner plates 2, 3. The second inner plate 3 has multiple second slots 31 which are located corresponding to the protrusions 12. The protrusions 12 are engaged with the second slots 31. In this embodiment, there are eighteen protrusions 12 and eighteen second slots 31.

The first inner plate 2 has eight first engaging holes 22 and the second inner plate 3 has eight second engaging holes 32 which are located corresponding to the first engaging holes 22. Bolts or rivets extend through the first and second engaging holes 22, 32 to connect the first and second inner plates 2, 3. The main plate 1 is movably connected between the first and second inner plates 2, 3.

The main plate 1 is movably connected between the first and second inner plates 2, 3. Due to the large contact area between the main plate 1 and the first and second inner plates 2, 3, the brake disk assembly of the present invention is more reliable and the wearing of the main plate 1 is reduced.

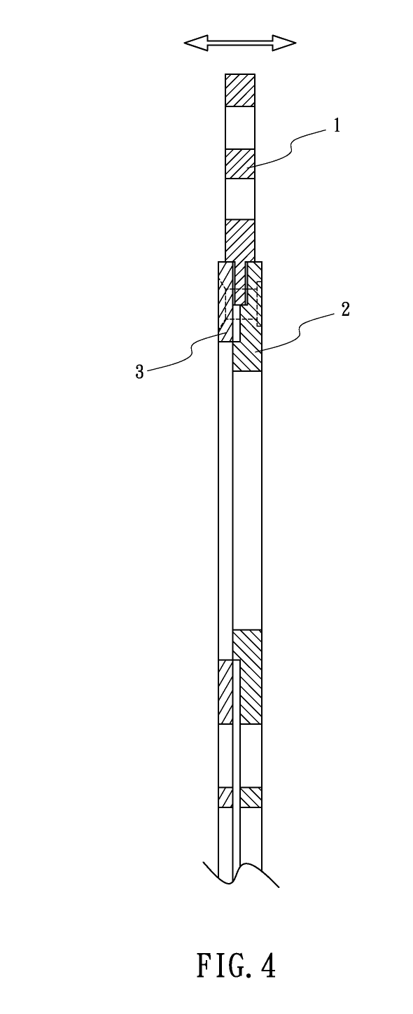

Referring to FIG. 4, the first and second inner plates 2, 3 respectively protrude from two sides of the main plate 1. Generally, the friction between the main plate 1 and the lining plates generate high heat so that one portion of the main plate 1 clamped by the lining plate tends to be deformed. The larger the diameter of the main plate 1 has, the more obvious irregular deformation along the peripheral of the main plate 1 is found, and the deformation affects the lining plates of the brake system to clamp the main plate 1 centrally during the rotation. Therefore, the present invention provides a feature that the main plate 1 is movable between the first and second inner plates 2, 3 so that even though the deformation is occurred, the main plate 1 can be clamped centrally by the lining plates to further prevent it from undesired deformation and this increase the life of use of the brake disk assembly.

Although the invention has been explained in relation to its preferred embodiment, it is to be understood that many other possible modifications and variations can be made without departing from the spirit and scope of the invention as hereinafter claimed.

What is claimed is:

1. A brake disk assembly comprising:
a main plate having a connection hole defined therethrough and multiple protrusions extending from an inner periphery of the connection hole;
a first inner plate having multiple first slots which are located corresponding to the protrusions, an outer periphery of the first inner plate connected with the connection hole; and
a second inner plate having multiple second slots which are located corresponding to the protrusions, an outer periphery of the second inner plate connected with the connection hole;
wherein the main plate is movably connected between the first and second inner plates; the large contact area between the main plate and the first and second inner plates leads to that the brake disk assembly is more reliable and the wearing of the main plate is reduced.

2. The brake disk assembly as claimed in claim 1, wherein the first and second inner plates are shaped to be correspondent to the connection hole.

3. The brake disk assembly as claimed in claim 1, wherein the first and second inner plates respectively protrude from two sides of the main plate.

4. The brake disk assembly as claimed in claim 1, wherein the first inner plate has first engaging holes and the second inner plate has second engaging holes which are located corresponding to the first engaging holes, bolts or rivets extending through the first and second engaging holes to connect the first and second inner plates.

5. The brake disk assembly as claimed in claim 1, wherein the main plate has multiple ventilation holes.
